(19) United States
(12) Patent Application Publication
(10) Pub. No.: US 2008/0022320 A1
(43) Pub. Date: Jan. 24, 2008

(54) Systems and Methods of Synchronizing Media Streams

(75) Inventor: William C. Ver Steeg, Alpharetta, GA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/428,336

(22) Filed: Jun. 30, 2006

(51) Int. Cl. H04N 7/173; H04N 7/18

(52) U.S. Cl. 725/78; 725/90; 725/112; 725/74

(57) ABSTRACT

Systems and methods are disclosed. One embodiment is a method of synchronizing media streams among a plurality of digital home communication terminals (DHCTs). The method comprises the steps of: decoding a stream of encoded media frames; receiving an indication of a desired playout time; determining a variation between the target playout time and the desired playout time; and adjusting the decoder playout speed to reduce the variation. At least a first portion of the frames have a target playout time conveyed in the stream. The indication of desired playout time is received for at least a second portion of the frames.

### CROSS REFERENCE TO RELATED APPLICATIONS

Not applicable.

### FIELD OF THE DISCLOSURE

The present disclosure relates to digital set-tops, and more specifically, to systems and methods of synchronizing media streams among multiple set-tops.

### BACKGROUND

A growing number of consumers now have high-speed, or broadband, connections to the Internet in their homes. The increased bandwidth provided by these broadband connections allows the delivery of digital television and/or video services to home consumers. One such technology for delivering digital television or video services uses the Internet Protocol (IP) as a transport mechanism. This technology is referred to as IP television, or IPTV.

IPTV makes use of a feature called “IP multicast” when delivering the same stream of television or video programming to a group of subscribers. The IP packets in the stream have the same IP destination address, which is a special type of address called a multicast address. All devices in the IP multicast group receive packets sent to that multicast address.

When a user commands an IPTV device, such as a computer or a set-top, to change channels, programming for the new channel may not be included in the currently received multicast stream. In that case, the IPTV device may join a new multicast group and receive a new multicast stream. The transition between receiving the original multicast stream (for the old channel) and the new multicast stream (for the new channel) is not instantaneous, and the user typically experiences a brief period of time where either no picture is displayed, or the picture from the original channel is frozen.

To reduce this period of time which the user experiences as channel change delay, some IPTV providers utilize a “fast channel change” or “instant channel change” mechanism. When this mechanism is used, programming on the new channel is delivered from a media cache server to the IPTV device, as a unicast or multicast stream, shortly after a channel change. When two IPTV devices change to the same new channel at approximately the same time, each starts decoding its respective cached stream at a slightly different time. The two IPTV devices are not synchronized, which can be undesirable, especially when the two devices are located near each other. Thus, a need arises for these and other problems to be addressed.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of an environment in which one embodiment of a system and method for synchronizing media streams is located.

FIG. 2 is a block diagram showing selected components of the DHCT of FIG. 1.

FIGS. 3A-F are data flow diagrams illustrating the exchange of information between components in the system of FIG. 1 during a fast channel change.

FIG. 4 illustrates a decoding timeline for two DHCTs including the synchronization logic of FIG. 1.

FIGS. 5A and 5B illustrate a flow chart of a method in accordance with one embodiment of the synchronization logic of FIG. 1.

### DETAILED DESCRIPTION

The embodiments disclosed herein provide systems and methods for synchronizing media streams in an IPTV environment. In one such embodiment, a digital home communication terminal (DHCT) is part of a peer synchronization group. DHCTs in the group receive information about the actual playout time of various frames decoded by another peer. The actual playout time of a peer decoder indicates a desired playback time in a local decoder. The local decoder playout speed is adjusted to reduce the variation between the desired playout time of a frame and the target playout time of the same frame. In this manner, the playout time of DHCTs in a peer group is synchronized with respect to each other.

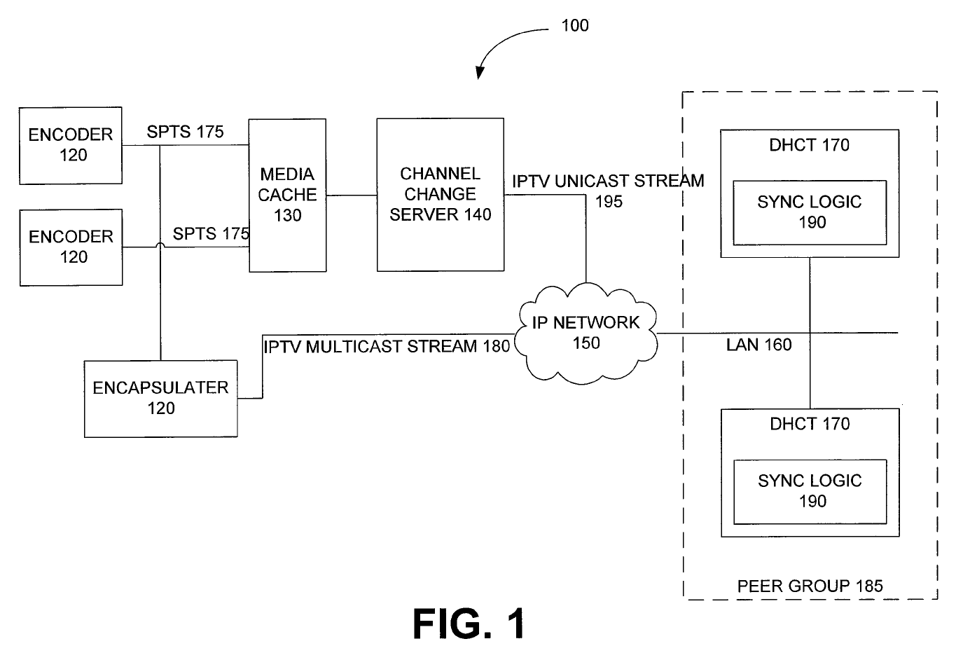

FIG. 1 is a block diagram of an environment in which one embodiment of a system and method for synchronizing media streams is located. System 100 delivers digital television and/or video services to subscribers using the Internet Protocol (IP). System 100 comprises: one or more media encoders 110; a multicast encapsulation device 120; a media cache 130; a channel change server 140; an IP multicast router 145, and IP network 150; a customer local area network (LAN) 160; and multiple digital home communication terminals (DHCT) 170.

Each encoder 110 takes as input an analog signal from a broadcast source of television or video programming, such as cable networks or on-air television stations, and outputs a digital stream that is compressed and encoded. Common encoding formats include MPEG-2, MPEG-4, and VC-1. In an IPTV environment, this digital stream represents a single program, so the stream typically contains a video and an audio stream multiplexed together into a single program transport stream (SPTS) 175. In this disclosure, the term “media stream” refers to a stream that includes video frames, audio frames, hypermedia, multimedia, or any combination thereof.

Multicast encapsulation device 120 encapsulates the SPTS in a stream of IP packets to produce IPTV multicast stream 180. In one embodiment, MPEG Transport Stream (TS) packets are encapsulated within IP packets. In another embodiment, the MPEG TS packets are encapsulated within RTP packets, which are in turn encapsulated within IP packets. In another embodiment, VC-1 streams are used.

IPTV multicast stream 180 is transmitted through IP multicast router 145 to IP network 150, then through LAN 160 to a group of DHCTs 170. Each DHCT 170 converts the stream of IPTV packets into a standard analog or digital video signal. DHCT 170 supplies the video signal to a display (for example, a television or computer monitor) for viewing by the customer. Some embodiments of DHCT 170 also provide interactive features, such as an electronic program guide (EPG), Web browser, and DVR (digital video recorder) functionality. In some embodiments, DHCT 170 takes the form of a set-top box. In others, DHCT 170 is implemented by a personal computer (PC).

When DHCT 170A and DHCT 170B are tuned to the same program source such as ABC, both are served by the single multicast IPTV stream 180. When DHCTs 170 change the channel to a new program source, system 100 uses IPTV unicast streams directed to particular DHCTs 170, or high-speed IPTV multicast streams, to reduce the time it takes a DHCT 170 to receive and decode a new program source. The use of unicast IPTV streams to speed up a channel change is often referred to as “fast channel change” or “instant channel change.”

DHCTs 170 form a peer group 185 and communicate with one another to synchronize playback after a fast channel change. Each DHCT 170 includes synchronization logic 190, which implements one of the systems and methods of synchronizing media streams disclosed herein. Without synchronization logic 190, DHCTs 170 that use fast channel change to switch to the same channel at approximately the same time will experience one DHCT 170 playing back slightly ahead of, or slightly behind, another DHCT 170.

In this example embodiment of system 100, peer group 185 communicates synchronization information via a customer LAN 160. However, other mechanisms for communication within peer group 185 are contemplated, such as Universal Serial Bus, FireWire, HomePNA, etc. In one embodiment, DHCTs 170 within peer group 185 are located in relative close proximity to each other, for example, in different rooms of the same building.

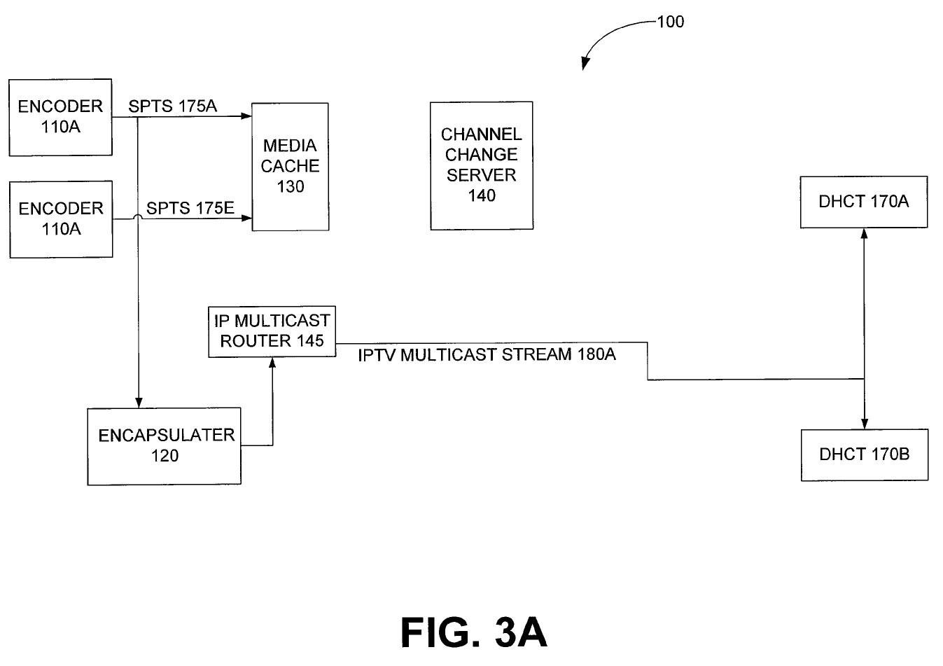

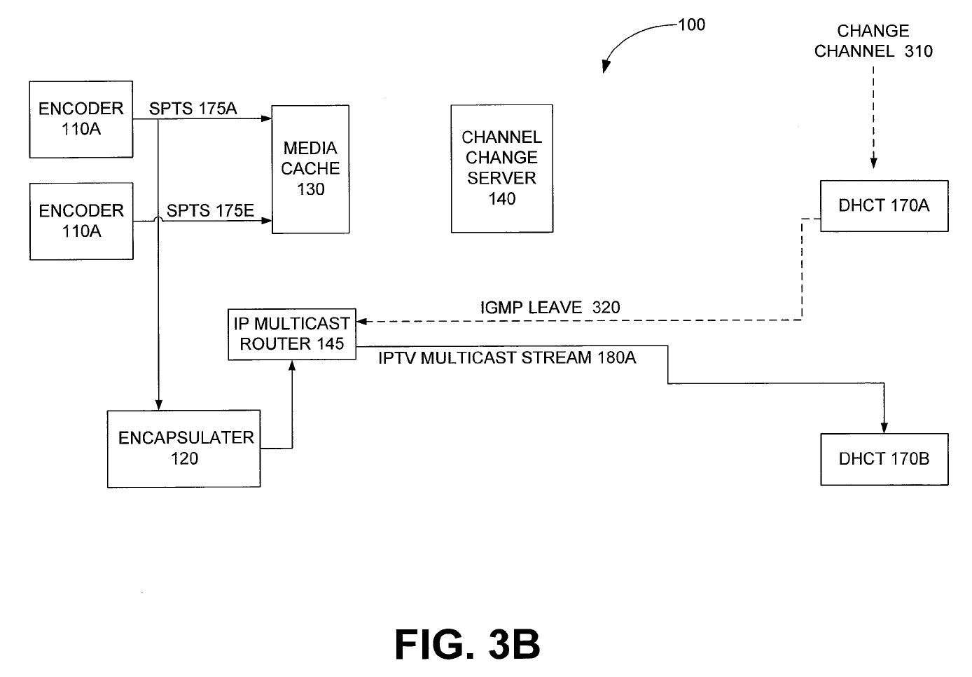

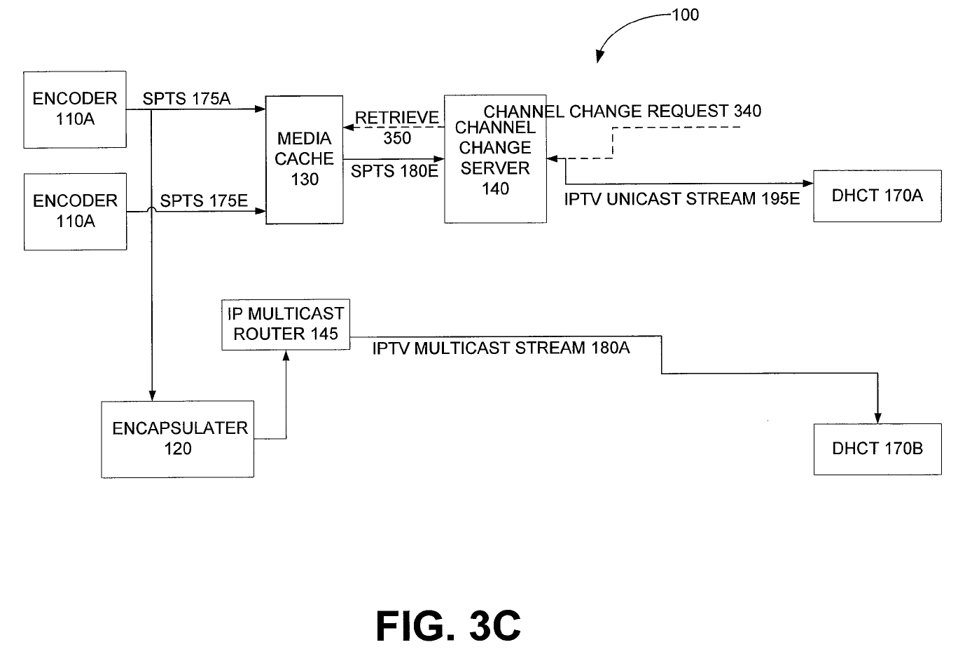

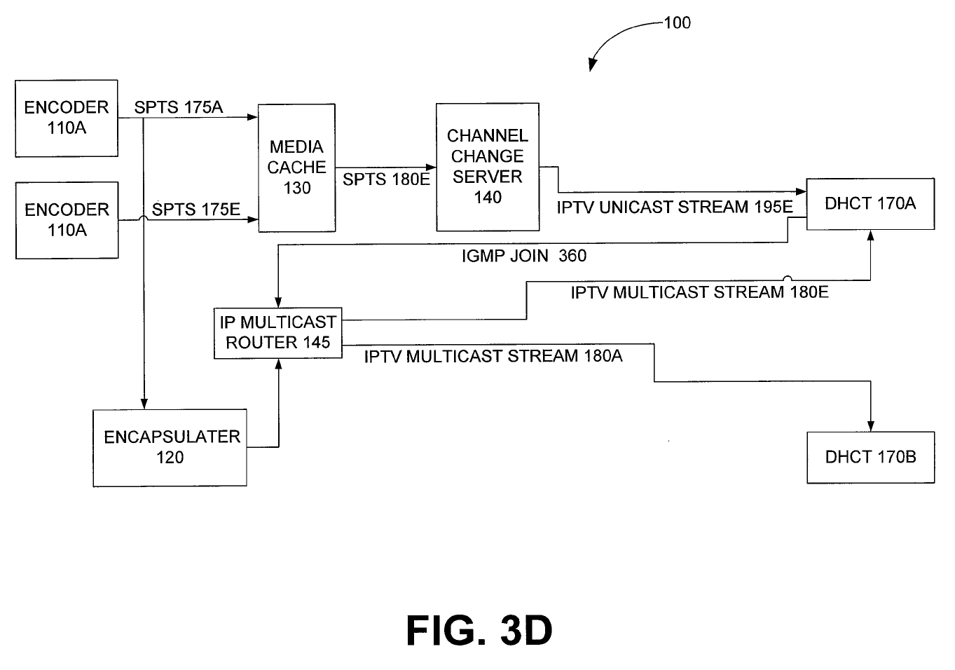

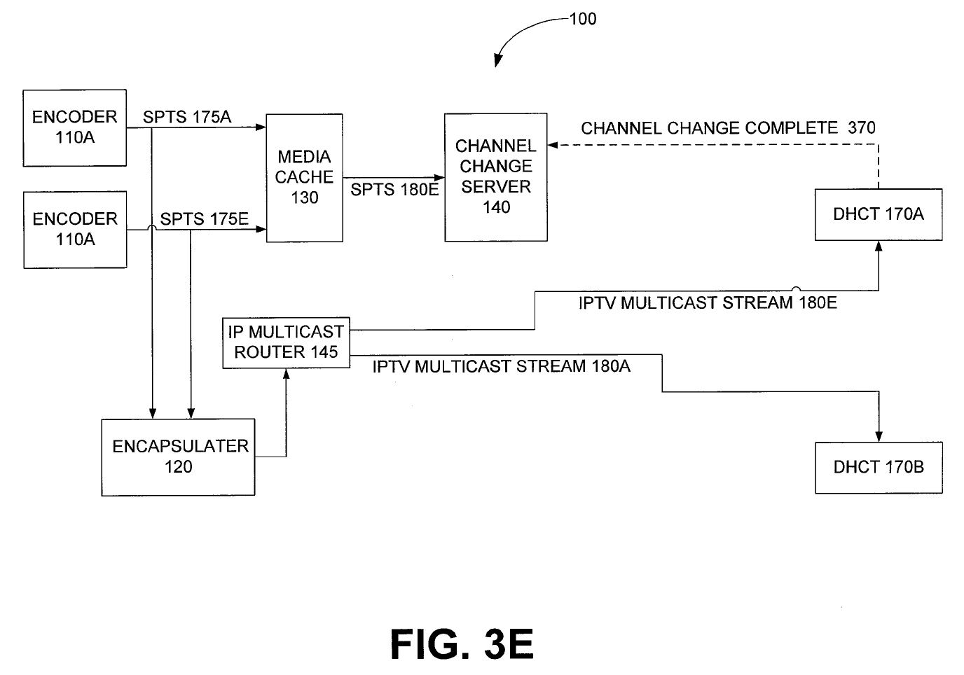

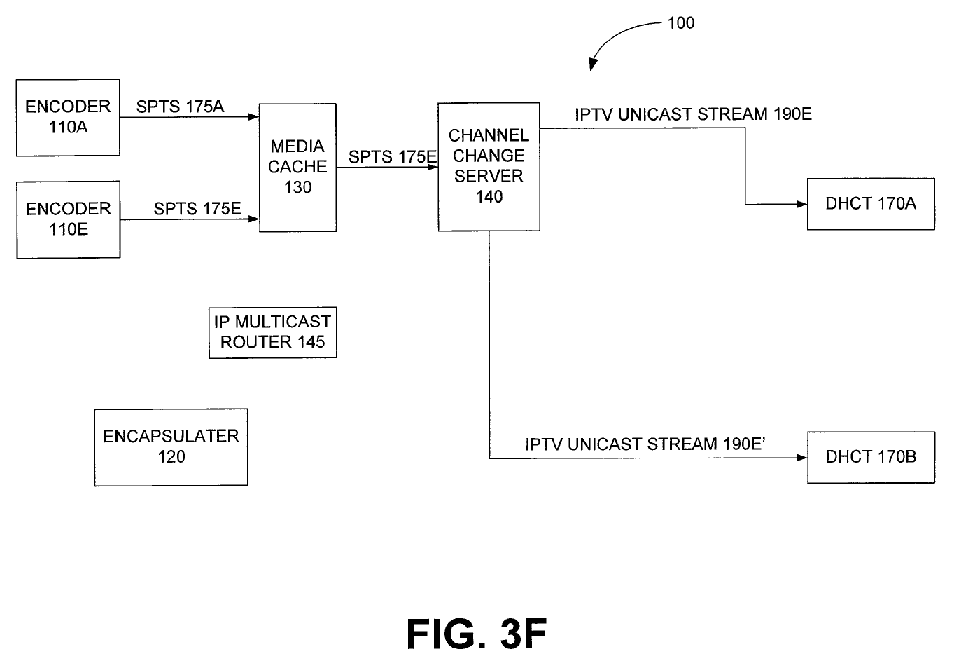

As explained above, IPTV multicast stream 180 is produced by multicast encapsulation device 120 from a single program transport stream (SPTS) 175 provided by an encoder 110. Media cache 130 receives SPTS's 175 from multiple encoders 110, and buffers each SPTS 175 for a short time, typically on the order of a few seconds. On request from a DHCT 170, channel change server 140 encapsulates a particular one of cached SPTS's 175 to produce an IPTV unicast stream 195 addressed to the requesting DHCT 170. The channel change process will be explained in more detail in connection with FIGS. 3-5.

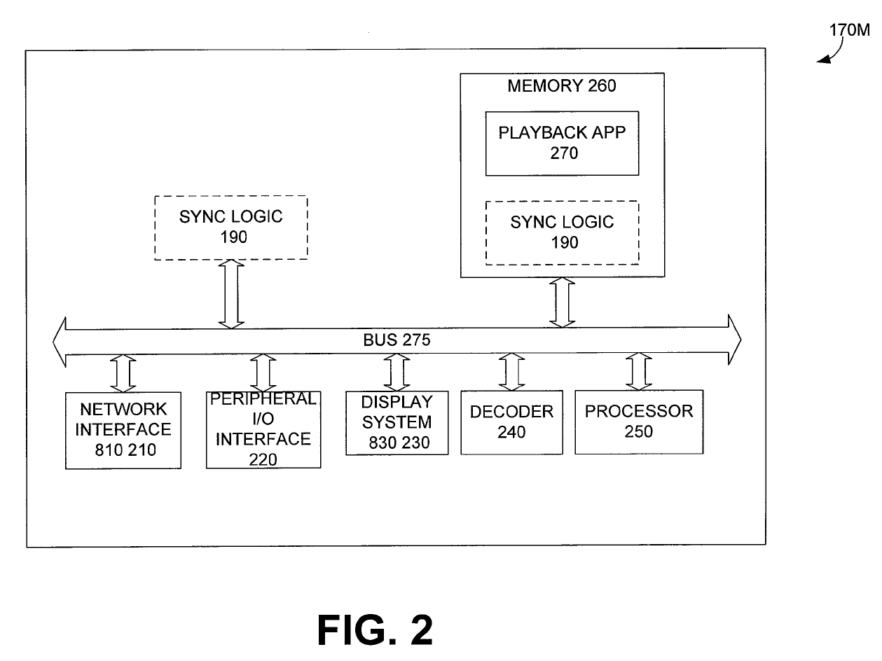

FIG. 2 is a block diagram showing selected components of DHCT 170. DHCT 170 comprises: a network interface 210; a peripheral I/O interface 220; a display system 230; a decoder 240; a processor 250; and memory 260. These components are coupled by a bus 275. Omitted from FIG. 2 are a number of conventional components, known to those skilled in the art, that are unnecessary to explain the operation of the systems and methods of synchronizing media streams disclosed herein.

Peripheral I/O interface 220 provides input and output signals, for example, user inputs from a remote control or front panel buttons or a keyboard, and outputs such as LEDs or an LCD on the front panel. Network interface 210 receives a stream of IPTV packets. Decoder 240 decodes the video packets encapsulated within the IPTV packets into a stream of decoded frames. Display system 230 converts the frames into a video signal for presentation on a display, such as a computer monitor or a television.

Memory 260 contains instructions that are executed by processor 250 to control operations of DHCT 170. Residing in memory 260 is a video/television playback application 270 for playback of received IPTV programming. Playback application 270 removes an MPEG stream that is encapsulated within the IPTV packets, and provides the MPEG stream to decoder 240. Synchronization logic 190 was introduced above in connection with FIG. 1 and will discussed further in connection with FIGS. 3-5. In one embodiment, synchronization logic 190 is implemented in software, and also resides in memory 260. In another embodiment, synchronization logic 190 is implemented in hardware, such as an field programmable gate array (FPGA) or application-specific integrated circuit (ASIC). In yet another embodiment, synchronization logic 190 is implemented by a combination of hardware and software.

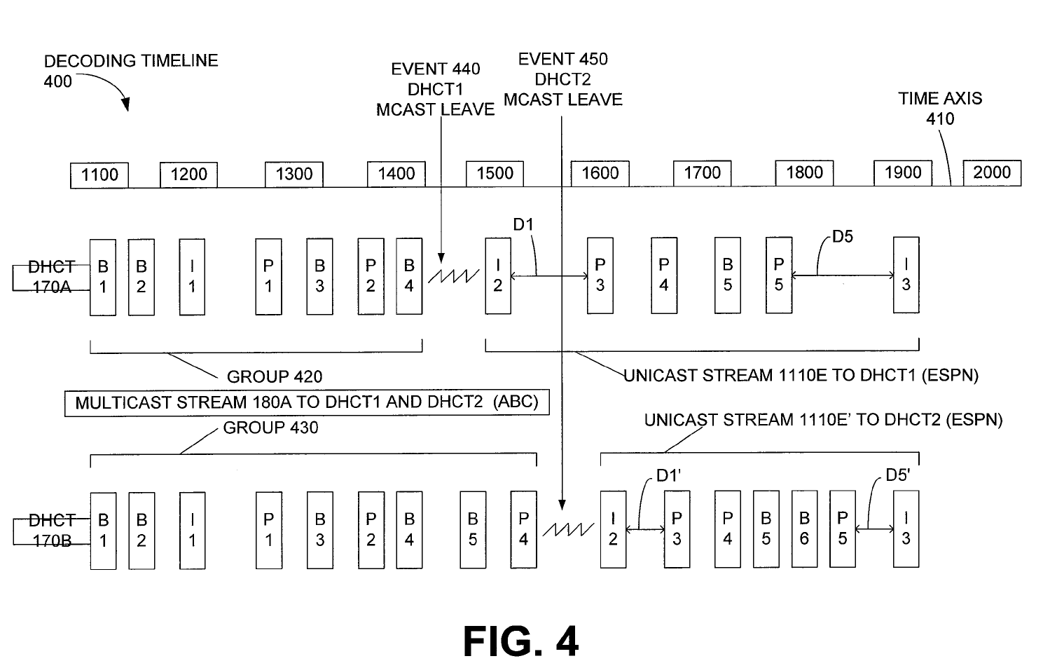

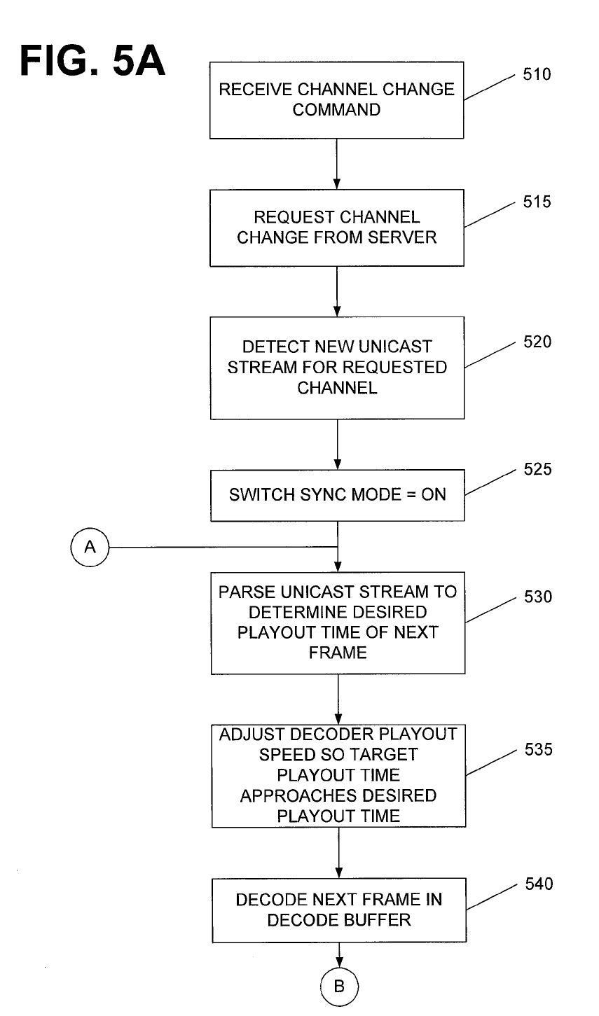

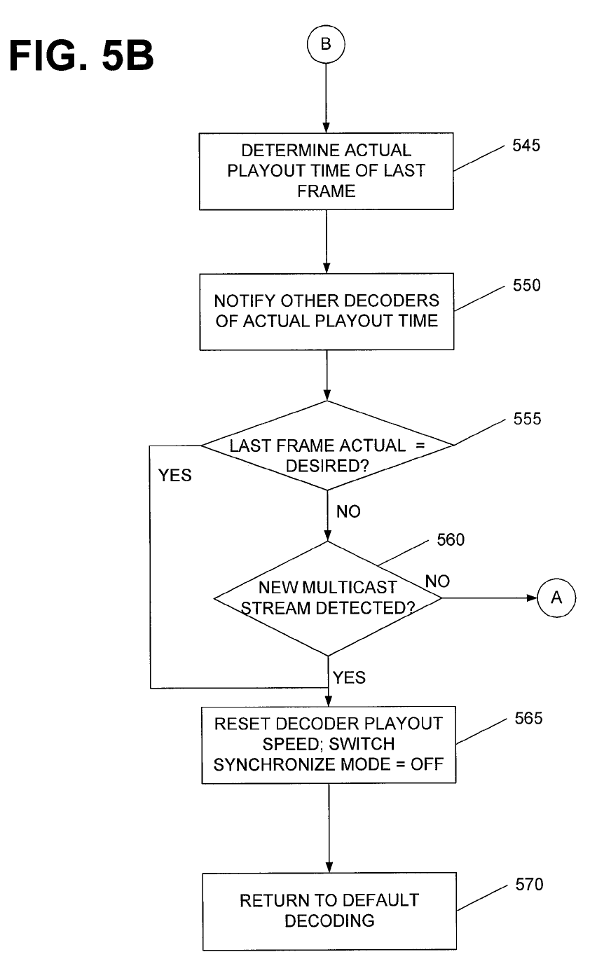

As described above, an IPTV channel change typically involves a DHCT 170 changing from one multicast group to another. The ultimate effect of changing DHCT membership is the DHCT will, at some point, stop decoding frames from one IPTV multicast stream, and at another point, start decoding frames from another IPTV multicast stream. For reasons that will be explained below in connection with FIGS. 4 and 5, this change is not instantaneous. To reduce the delay in what a user experiences as a channel change, channel change server 140 provides the requesting DHCT with a cached stream carrying the requested channel for the time between the switchover from the multicast stream carrying the original channel to the multicast stream carrying the new channel.

The fast channel change process will now be explained in connection with the data flow diagrams of FIGS. 3A-E, which illustrate the exchange of information between components in system 100 during a fast channel change. Some of the connections in system 100 have been simplified, for example, IP network 150 and LAN 160 are not shown, and multicast and unicast streams are shown as logical channels between devices.

FIG. 3A shows the initial state of system 100. DHCT 170A and DHCT 170B are both tuned to the same program source (here, ABC) and are both receiving IPTV multicast stream 180A. IPTV multicast stream 180A is produced by multicast encapsulation device 120, using the stream from encoder 110A.

The initial sequence of events which occurs in a fast channel change is shown in FIG. 3B. DHCT 170A receives (through event 310) a channel change command instructing the DHCT to switch to another program source (here, ESPN). In one embodiment, channel change event 310 is generated by a remote control. In response to channel change event 310, DHCT 170A sends a request (320) to IP multicast router 145, asking to be removed from the IP multicast group associated with the current channel (here, ABC). In this example embodiment, request 320 is implemented using an Internet Group Membership Protocol (IGMP) Leave message. In response, IP multicast router 145 stops sending IPTV multicast stream 180A to the requesting DHCT 170A. Note that DHCT 170B continues to receive IPTV multicast stream 180A.

The next sequence of events is shown in FIG. 3C. To reduce the delay in what a user experiences as a channel change, DHCT 170A requests a cached stream the new channel before joining the multicast group associated with the new channel. More specifically, after leaving the multicast group, DHCT 170A sends a channel change request 340 to channel change server 140. In response to channel change request 340, channel change server 140 requests (350) the appropriate buffered SPTS from media cache 130. Here, the appropriate buffered stream is SPTS 175E, produced by encoder 110E, since that stream corresponds to the requested new channel ESPN. Channel change server 140 encapsulates SPTS 175E to produce IPTV unicast stream 195E, which is addressed specifically to the DHCT that requested the channel change (DHCT 170A).

The next sequence of events is shown in FIG. 3D. After receiving the cached stream 110E, DHCT 170A sends a request 360 to the IP multicast router 145, asking to be added to IP multicast group associated with the new channel (here, ESPN). In response, IP multicast router 145 sends a different IPTV multicast stream 180E, carrying the newly requested channel, to the requesting DHCT 170A. Note that DHCT 170B continues to receive IPTV multicast stream 180A.

The final sequence of events is shown in FIG. 3E. Upon receipt of IPTV multicast stream 180E, DHCT 170A notifies (370) channel change server 140 that the channel change is complete. In response to notification 370, channel change server 140 stops sending IPTV unicast stream 195. At this point, the fast channel change requested by DHCT 170A is complete, and DHCT 170A and DHCT 170B are now receiving different channels.

FIG. 3F shows another scenario in which DHCT 170B has requested a fast channel change to the same channel as did DHCT 170A. At the point in time shown in FIG. 3F, both channels are receiving a separate unicast stream from channel change server 140: DHCT 170A is receiving IPTV unicast stream 195E; and DHCT 170B is receiving IPTV unicast stream 195E′. Neither is yet receiving an IPTV multicast stream carrying the newly requested channel.

Both unicast streams, 190E and 190E′, carry the same program and are transmitted from channel change server 140. But because the two unicast streams are independent, decoding in DHCT 170A starts at a slightly different time DHCT 170B. As will be discussed further in connection with FIGS. 4-5, synchronization logic 190 in DHCTs 170 adjusts the playback so that both decoders are once again synchronized.

FIG. 4 illustrates a decoding timeline 400 for DHCT 170A and DHCT 170B, and results achieved by synchronization logic 190. The output of the video decoder of DHCT 170A appears in the top half of the diagram, immediately beneath the timeline axis 410, and the output of the video decoder of DHCT 170B appears below that, in the lower half of the diagram. In this diagram, events occurring first in time appear on the left. In this example, timeline axis 410 is marked in units of 100 ms.

The first group (420) of frames received by DHCT 170A and the first group (430) of frames received by DHCT 170B are part of a common multicast stream 180A, here carrying channel ABC. From the channel change point of view, a single stream 180A is transmitted to an IP multicast address. An IP multicast router (not shown) transmits a copy of each frame in the stream to each DHCT 170 that is part of the multicast group. Thus, as shown in FIG. 4, each DHCT 170 receives and decodes its own copy of these frames.

At the start, beginning with T=110, both DHCTs 170 are synchronized: a received B-frame (B1) is decoded at T=1100, then another B-frame (B2) is decoded, then a first I-frame (I1) is decoded at T=1200, etc. When DHCT 170A changes channels and leaves the multicast group “ABC” (event 440), synchronization is lost. DHCT 170B continues to receives frames from the multicast stream “ABC” (180A): another B-frame (B5), then another P-frame (P4). Note that at the time DHCT 170B decodes frame B5, DHCT 170A has stopped decoding because no stream is being received.

The DHCTs 170 lose synchronization shortly after DHCT 170A receives and decodes frame B4. At T=1500, DHCT 170A receives the first frame in a new unicast stream 195E. This unicast stream 195E, carrying the new channel “ESPN”, is directed solely to DHCT 170A. During this time, DHCT 170B continues to receive and decode the multicast stream “ABC” (180A). Thus, the DHCTs 170 are no longer synchronized after frame B5.

Between T=11500 and T=1600, DHCT 170B also changes channels, leaving the multicast group “ABC” at event 450. Shortly after T=1600, DHCT 170A receives the first frame in a new unicast stream 195E′. This unicast stream 195E′ carries the same video frames as does stream 195E—frames I2, P3, P4, B5, P5 and I3—but is a separate stream is directed solely to DHCT 170B.

Synchronization logic 190 within each DHCT 170 adjusts the decoder playout rate of received frames so that the lag between the two decoders is iteratively decreased. As can be seen in FIG. 4, DHCTs 170 regain synchronization by T=1900. The techniques used by synchronization logic 190 to regain synchronization will be explained further in connection with FIGS. 5A-B, and the results will be described here.

Frame 12 is decoded by DHCT 170A at T=1500. The same frame 12 is decoded by DHCT 170B shortly after T=1600. Thus, DHCT 170B initially lags DHCT 170A by over 100 ms. Through mechanisms discussed in connection with FIGS. 5A-B, synchronization logic 190 in DHCT 170B is notified of this difference D1, and speeds up decoder playout rate so that the difference (D1′) between I2 and P3 decoded in DHCT 170B is less than D1.

At the point described so far, DHCT 170B has reduced the lag somewhat after decoding P3. Accurate synchronization would require that DHCT 170B decode P3 at 1600. Maintaining intra-frame decoding time, as described by decoding or presentation timestamps in the stream, would require that DHCT 170B decode P3 at 100 ms after I2, or T=1712. DHCT 170B instead increases the decoder playout rate to decode P3 early, at T=1675. Thus, after decoding P3, DHCT 170B is only 75 ms behind DHCT 170A, instead of the initial lag of 100 ms.

DHCT 170B continues to reduce the lag by further increasing the playout rate as necessary. For example, the difference (D5) between decoding P5 and I3 in DHCT 170A is 125 ms. DHCT 170B has reduced the corresponding difference (D5′) to 63 ms (1900-1837). The two DHCTs 170 have regained synchronization by T=1900, with the decoding of I3 by both DHCTs 170.

In this example, the difference in decode time between each pair of successive frames in DHCT 170B continues to be reduced as compared to DHCT 170A. However, this is merely an example, and it is not required that synchronization logic 190 reduce lag with each decoded frame. In some cases, the target decode time (expressed through presentation or decode timestamps in the media stream) is too soon to allow an earlier decode. In other cases, an earlier target decode time would reduce lag, but would result in artifacts that are undesirable to the user. Various methods of adjustment are contemplated which result in the actual playout time of successive frames in DHCT 170B approaching, or converging on, the actual playout time of the corresponding frames in DHCT 170A.

In the embodiment illustrated in FIG. 4, synchronization logic 190 in DHCT 170B is notified of actual playout times for frames decoded by DHCT 170A. These actual playout times from the peer DHCT (170A) act as an indication of a desired time for playout in the local DHCT(170B. DHCT 170B then compensates for the lag by speeding up decoder playout. In another embodiment, synchronization logic 190 in DHCT 170A is notified of actual playout times for frames decoded by DHCT 170B, and compensates for the lag by slowing down decoder playout in DHCT 170A.

Exemplary mechanisms for distributing actual playout times for decoded frames within peer group 185 will be discussed in connection with FIG. 5. A person of ordinary skill in the art should understand that the process described herein for adjusting a video decoder's playout speed also applies to adjusting the playout speed of an audio decoder, since synchronization of the audio stream and the video stream for the same program is accomplished by using common target decode times for audio and video frames.

FIGS. 5A-B illustrate a flow chart of a method in accordance with one embodiment of synchronization logic 190. Processing begins at block 510, where DHCT 170 receives a channel change command, for example, from a remote control. Next, at block 515, DHCT 170 requests a channel change from channel change server 140. At block 520, synchronization logic 190 waits for detection of the reception of a new unicast stream carrying the requested channel. The next block (525) sets a peer synchronization mode flag is to Off. This block (525) is optional. In one embodiment, the default frame decode processing in DHCT 170 checks this flag and performs normal decoding if the flag is Off.

Processing continues at block 530, where the unicast stream is parsed to determine the desired playout time of the next frame. In one embodiment, synchronization logic 190 performs the parsing. In yet another embodiment,

In some embodiments, the desired playout time information is provided by a peer DHCT 170. For example, each peer DHCT 170 in a specific multicast group associated with the newly requested channel could transmit, via the group multicast address, the actual playout time of all or a portion of its own decoded frames. In one such embodiment, the timing information is carried in IP packets rather than in the MPEG transport stream (“out-of-band” signaling). In another embodiment, the timing information is conveyed in the IP multicast stream as part of the MPEG transport stream.

In yet other embodiments, the desired playout time information is provided to DHCTs 170 by channel change server 140 as part of the MPEG transport stream. The transport stream is modified to include an indication of the clock time referenced for one or more frames. Each DHCT skews its playback to match the clock included in the stream. The clock reference may be encoded using MPEG private data, RTP headers, or other mechanisms.

In yet another embodiment, each DHCT 170 is configured to have the same target delay, and synchronization logic 190 varies the playout speed of its decoder until the fixed target delay is achieved. Since DHCTs in the peer group receive multicast data at the same time, and both use the same target delay for presentation, the streams regain synchronization.

At block 535, the playout speed of the decoder (240 in FIG. 2) is adjusted in a manner such that the target playout time of the next frame approaches the desired playout time. The media stream contains a target playout time for at least some of the frames, for example, expressed as decode time stamps (DTS) and/or presentation time stamps (PTS), which in some embodiments are extracted by an elementary stream parser in DHCT 170.

For frames that do not have an associated target playout time in the media stream, the target playout time can be interpolated from surrounding frames. Note that a decoding a particular frame at its associated target decode time is not a hard requirement for a decoder, and in some situations a decoder may instead decode at substantially or approximately the target time. Target presentation times are treated in a similar manner.

An example of an adjustment in playout speed follows. If decoding in the DHCT 170 lags 400 ms behind a peer DHCT 170, and the target playout time of the next frame before adjustment is 500 ms, then the playout speed could be adjusted such that the target playout time of the next frame becomes 400 ms, thus reducing the lag from 400 ms to 300 ms. Conversely, if decoding in the DHCT 170 is 400 ms ahead of a peer DHCT 170, the playout speed could be adjusted to delay the target playout time of the next frame. Thus, the variation between target playout time and desired playout time is monitored, and playout speed is adjusted to reduce the variation.

In some embodiments, playout speed is adjusted through decoder settings, for example, by writing to decoder registers or sending decoder commands. The adjustment may be absolute or relative (such as 2× or −10%). In other embodiments, playout speed is adjusted by adjusting the oscillator used by the decoder.

In yet another embodiment, rather than adjusting an overall playout speed, the playout time of a frame is set directly by changing the decode time stamp (DTS) and/or presentation time stamp (PTS) associated with the next frame. The DTS and/or PTS are carried in the single program transport stream. The DTS instructs the decoder as to a target time for removing a frame from the decode buffer and decoding it. The PTS instructs the decoder as to a target time for presenting the decoded frame to the display system.

After the playout speed is adjusted in block 535, processing continues at block 540, where the next frame is retrieved from the decode buffer and decoded at the current playout speed. Next, the actual playout time of the just-decoded frame is determined (block 545 in FIG. 5B) and other decoders are notified of the actual playout time (block 550 in FIG. 5B). Block 555 determines if the playout time of the last frame is equal to the desired playout time (from block 530). The comparison may take into account a tolerance level, so that exact equality is not required. If the two times are equal, then synchronization of the DHCT 170 with its peer has been achieved. Processing continues at block 565, which will be described below.

If the determination is made in block 555 that the playout time of the last frame is not equal to the desired playout time, then block 560 determines if a new multicast stream, carrying the newly requested channel, has been received. If no new multicast stream has been detected, then processing returns to block 530, where the next frame is handled.

If a new multicast stream is available, then synchronization is no longer required. The normal decoding process for a multicast stream involves waiting for the next I-frame before decoding. Because both DHCTs 170 wait for the next I-frame, and both DHCTs 170 are receiving the same multicast stream, eventual synchronization is a natural result of handling a multicast stream synchronization logic 190 is then disabled in blocks 565 and 570. At block 565, the decoder playout speed is reset to a default value, and the peer synchronize mode flag is set to Off.

At block 570, normal decoding and oscillation adjustment resumes, in which the oscillation rate is adjusted by comparing the PCR in the stream to the running rate of the oscillator. If the streams lose synchronization again, the peer synchronization flag is set again, which results in the adjustment algorithm of blocks 530-565 being re-instated.

Any process descriptions or blocks in flowcharts should be understood as representing modules, segments, or portions of code which include one or more executable instructions for implementing specific logical functions or steps in the process. As would be understood by those of ordinary skill in the art of the software development, alternate implementations are also included within the scope of the disclosure. In these alternate implementations, functions may be executed out of order from that shown or discussed, including substantially concurrently or in reverse order, depending on the functionality involved.

The systems and methods disclosed herein can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) an optical fiber and a portable compact disk read-only memory (CD-ROM).

The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

What I claim is:

1. A method, performed in a digital home communication terminal (DHCT), of synchronizing media streams among a plurality of DHCTs, the method comprising the steps of:
decoding a stream of encoded media frames at a playout speed, at least a first portion of the frames having a target playout time conveyed in the stream;
receiving an indication of a desired playout time for at least a second portion of the frames;
determining a variation between the target playout time and the desired playout time; and
adjusting the decoder playout speed to reduce the variation.

2. The method of claim 1, wherein the indication of the desired playout time of a frame corresponds to the actual playout time of the corresponding frame in another one of the plurality of DHCTs.

3. The method of claim 1, wherein the adjusting step further comprises:
increasing the playout speed if the variation indicates that decoding in the DHCT lags behind decoding in another one of the plurality of DHCTs.

4. The method of claim 1, wherein the adjusting step further comprises:
decreasing the playout speed if the variation indicates that decoding in the DHCT precedes decoding in another one of the plurality of DHCTs.

5. The method of claim 1, further comprising:
receiving the indication of the desired playout time from another one of the plurality of DHCTs.

6. The method of claim 1, further comprising:
transmitting a channel change request to a channel change server; and
receiving the indication of the desired playout time from the channel change server.

7. A digital home communication terminal (DHCT) comprising:
a network interface configured to receive a media stream of encoded frames;
a decoder having a playout speed and configured to decode each of the encoded frames into a decoded frame at a corresponding target playout time;
logic configured to determine a target playout time for at least a first portion of the encoded frames;
synchronization logic configured to:
detect a channel change command associated with a target channel;
detect reception of a unicast Internet Protocol (IP) stream associated with the target channel;
responsive to the unicast detection, enter a synchronization mode in which the synchronization logic is further configured to:
determine a desired playout time for at least a second portion of the encoded frames;
determine a variation between the target playout time and the desired playout time; and
adjust the decoder playout speed to reduce the variation.

8. The system of claim 7, wherein the indication of the desired playout time of a frame corresponds to the actual playout time of the corresponding frame in another one of the plurality of DHCTs.

9. The system of claim 7, wherein the DHCT is part of a peer synchronization group, and the synchronization logic further comprises:
logic configured to determine the desired playout time for at least the second portion of the encoded frames from a stream transmitted by another DHCT in the peer synchronization group.

10. The system of claim 9, wherein the desired playout time is conveyed within an MPEG transport stream carried in the transmitted stream.

11. The system of claim 9, wherein the transmitted stream comprises IP packets, and the desired playout time is conveyed in one of the IP packets.

12. The system of claim 7, further comprising:
logic configured to detect reception of a multicast IP stream associated with the target channel; and
logic configured to exit the synchronization mode and reset the decoder playout speed in response to the multicast detection.

13. The system of claim 7, further comprising:
logic configured to detect a convergence between the target playout time and the desired playout time;
logic configured to exit the synchronization mode and reset the decoder playout speed in response to the convergence detection.

14. A computer-readable medium having a computer program for processing data comprising:
logic configured to decode a stream of encoded media frames at a playout speed, at least a first portion of the frames having a target playout time conveyed in the stream;
logic configured to receive an indication of a desired playout time for at least a second portion of the frames;
logic configured to determine a variation between the target playout time and the desired playout time; and
logic configured to adjust the playout speed to reduce the variation.

15. The computer-readable medium of claim 14, further comprising:
logic configured to increase the playout speed if the variation indicates that decoding lags behind decoding by a decoder in a peer synchronization group.

16. The computer-readable medium of claim 14, further comprising:
logic configured to decrease the playout speed if the variation indicates that decoding precedes decoding by a decoder in a peer synchronization group.

17. The computer-readable medium of claim 14, further comprising:
logic configured to receive the indication of the desired playout time from a peer in a synchronization group.

18. The computer-readable medium of claim 14, further comprising:
logic configured to transmit a channel change request to a channel change server; and
logic configured to receive the indication of the desired playout time from the channel change server.

19. The computer-readable medium of claim 14, further comprising:
logic configured to detect reception of a multicast IP stream associated with the target channel; and
logic configured to exit the synchronization mode and reset the decoder playout speed in response to the multicast detection.

20. The computer-readable medium of claim 14, further comprising:
logic configured to detect a convergence between the target playout time and the desired playout time;
logic configured to exit the synchronization mode and reset the decoder playout speed in response to the convergence detection.
